(19) United States
(12) Patent Application Publication
(10) Pub. No.: US 2014/0312167 A1
(43) Pub. Date: Oct. 23, 2014

(54) Ram Air Fan Mounting Bracket

(71) Applicant: HAMILTON SUNDSTRAND CORPORATION, Windsor Lacks, CT (US)

(72) Inventors: Caroline Rupp, Manchester, CT (US); William R. Fiske, Springfield, MA (US)

(21) Appl. No.: 13/865,383

(22) Filed: Apr. 18, 2013

(51) Int. Cl. B64D 27/26

(52) U.S. Cl. CPC B64D 27/26
USPC 244/54

(57) ABSTRACT

A bracket has an axial rear wall to be secured to a housing for a ram air fan and a base floor defined between lateral sidewalls. The base floor has a slot extending for an axial length and for a lateral width, with a ratio of the length to the width being between 1.24 and 1.29. A ran air fan, a system and a method are also disclosed.

### BACKGROUND

This application relates to a unique mounting bracket for use in attaching a ram air fan to a remainder of a pack included in a cabin air conditioning and temperature control system (“CACTCS”).

As utilized on aircraft, cabin air is treated in a system that must provide air at an acceptable temperature for circulation within a cabin. In one cabin air conditioning and temperature control system, air is taken from a compressor and passed through an air cycle machine, and through a main heat exchanger. The air may be somewhat hot. Thus, a ram air fan is included, which takes air from an environment outside of the aircraft, and drives that air across the heat exchanger cooling the air within the heat exchanger. The cooled air may then be delivered into the aircraft cabin.

The ram air fan must be mounted adjacent to the remainder of the pack of equipment incorporated into the CACTCS. Historically, mounting brackets have attached a lower portion of the ram air fan housing to the pack.

### SUMMARY

A bracket is used for securing a ram air fan to a pack for a cabin air conditioning and temperature control system. An axial rear wall of the bracket is to be secured to a housing for a ram air fan and includes bolt holes with a base floor defined between lateral sidewalls. The base floor has a grooved surface and a slot extending through the base floor. The slot extends for an axial length and for a lateral width, with a ratio of the length to the width being between 1.24 and 1.29. A ram air fan, a system and a method are also disclosed.

These and other features may be best understood from the following drawings and specification.

### BRIEF DESCRIPTION OF THE DRAWINGS

FIG. 1 schematically shows a cabin air conditioning and temperature control system.

FIG. 2A shows a ram air fan.

FIG. 2B shows a bracket.

FIG. 2C shows a feature of the bracket.

FIG. 3 shows dimensions of the bracket.

### DETAILED DESCRIPTION

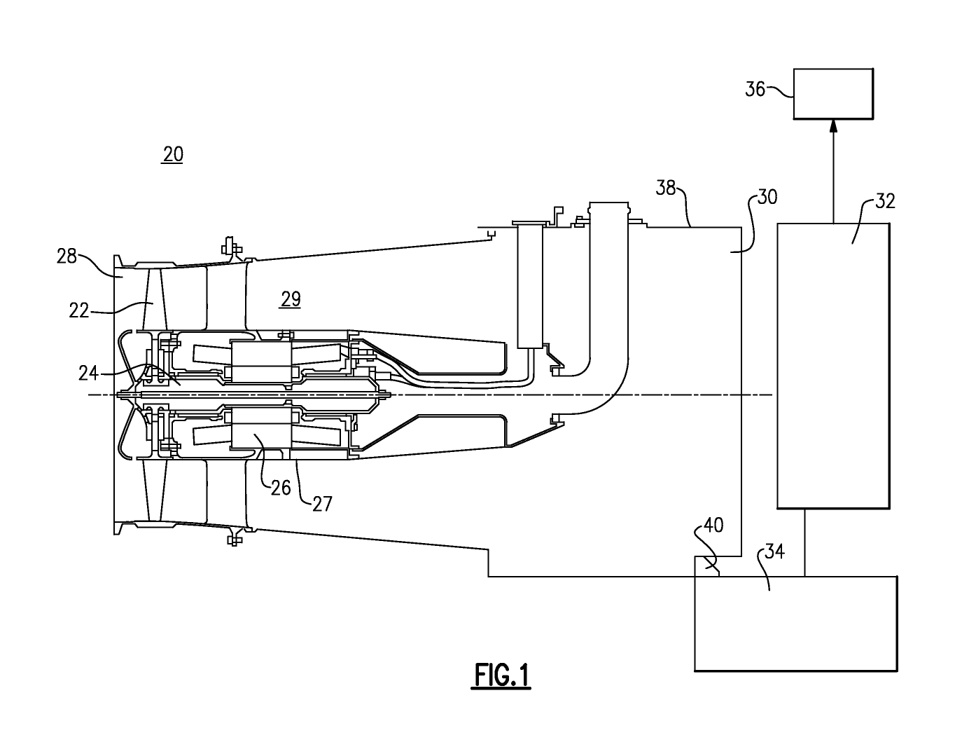

A ram air fan 20 is shown in FIG. 1 having a fan rotor 22 driven by a motor rotor 24, which is driven by a motor stator 26. A fan duct 29 is defined outwardly of a motor housing 27 and inwardly of an outer housing 38. The fan rotor 22 takes air from an inlet 28 and delivers the air to an outlet 30. As known, the inlet 28 may communicate with an environment outside of an aircraft incorporating the ram air fan 20. An air cycle machine and the remainder of a pack 34, which forms a portion of a CACTCS delivers air through a heat exchanger 32 for use in an aircraft cabin 36. The outlet air 30 is driven across the heat exchanger 32 and serves to cool the air within the heat exchanger 32 prior to its being delivered to the cabin 36.

As shown in FIG. 1, the components 32 and 34 are greatly simplified. There are any number of controls and features incorporated into these components.

A bracket 40 is shown for mounting the housing 38 of the ram air fan 20 to the pack 34. Included in the pack 34 is an air cycle machine for driving the air from a compressor and through the heat exchanger 32, and further for moving the air into a cabin 36 of an air associated aircraft.

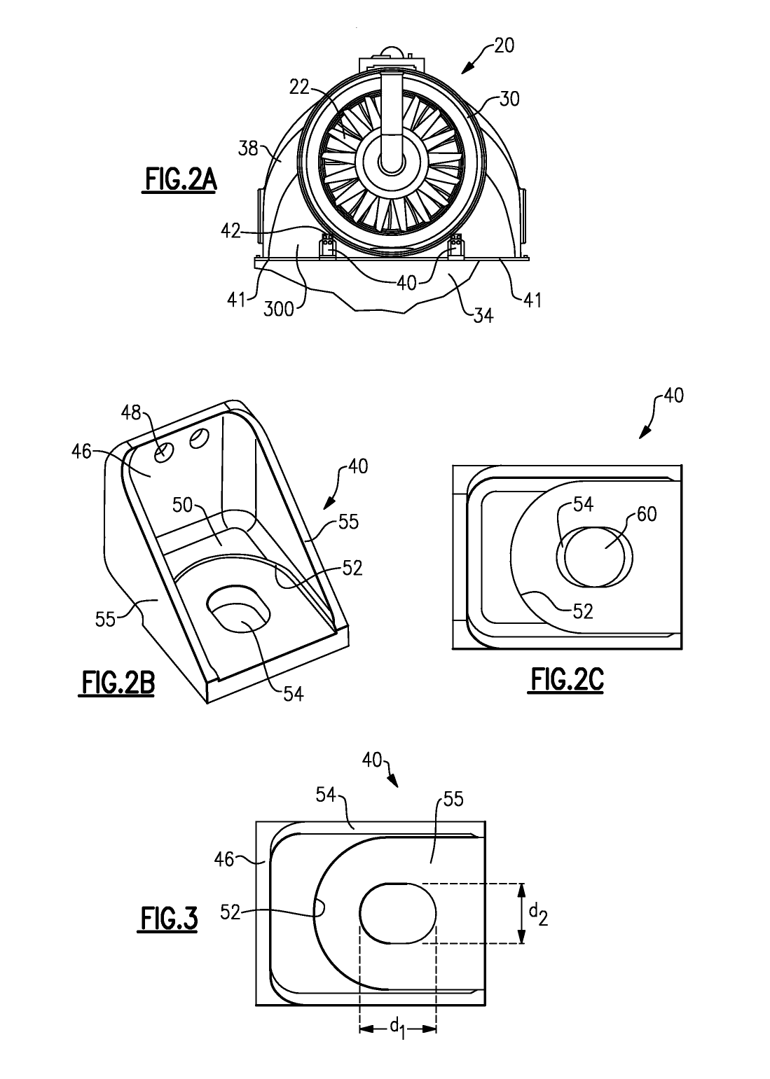

As shown in FIG. 2A, the housing 38 extends about the rotor 22 and the outlet 30. Fan bypass ducts 41 are defined at each lateral side of a bracket 40. The brackets 40 mount the housing 38 to the pack 34. The housing 38 may be formed of a composite material. The brackets 40 are mounted on a forward face 300 of the housing 38, formed radially outwardly of the outlet 30.

As shown in FIG. 2B, the bracket 40 includes a rear wall 46 which receives bolts 42 (see FIG. 2A) extending through holes 48 to secure the bracket 40 to the housing 38. A base floor 50 of the bracket 40 is defined between lateral sidewalls 55. A grooved surface 52 is formed about a slot 54.

As shown in FIG. 2C, the slot 54 receives the bolt 60 and the slot 54 is larger in a length or axial dimension, which is parallel to a rotational axis of the fan rotor 22 than it is in a width dimension defined perpendicularly to the axial dimension. This allows the position of the bolt 60 to adjust within the slot 54 to allow for tolerance stack up. This becomes particularly important for use with a composite housing 38, which has a greater tolerance range.

As shown in FIG. 3, the slot 54 has a length dimension d₁ along an axial distance. It has a dimension d₂ along a width distance perpendicular to the axial dimension. In one embodiment, d₁ was 0.670 inch+/−0.005 inch (1.7018 centimeters+/−0.0127 centimeters). The d₂ was 0.530 inch+/−0.005 inch (1.3462 centimeters+/−0.0127 centimeters). In embodiments, a ratio of d₁ to d₂ was between 1.24 and 1.29.

With the inventive bracket 40, the housing 38 may be easily secured to the remainder of the pack 34 and accommodate tolerance stack-up concerns.

A method includes the steps of removing bolts 42 to allow a pack 34 to be separated from a ram air fan 20 at a bracket 40. The bracket 40 is removed from a housing 38. The removed bracket is replaced with a replacement bracket 40.

Although an embodiment of this invention has been disclosed, a worker of ordinary skill in this art would recognize that certain modifications would come within the scope of this disclosure. For that reason, the following claims should be studied to determine the true scope and content of this disclosure.

1. A bracket for use in securing a ram air fan to a pack for a cabin air conditioning and temperature control system comprising:
an axial rear wall to be secured to a housing for a ram air fan and including bolt holes, a base floor defined between lateral sidewalls, said base floor having a grooved surface and a slot extending through said base floor; and
said slot extending for an axial length and for a lateral width, with a ratio of said length to said width being between 1.24 and 1.29.

2. A ram air fan comprising:
a fan rotor and a motor having a motor rotor driven by a motor stator, with said motor rotor and said motor stator received within a motor housing;
a fan duct defined between an outer peripheral surface of said motor housing and an inner peripheral surface of a fan housing;
an inlet to said fan rotor defined at one axial end of said fan housing, and an outlet defined at an opposed axial end, with said fan housing having a forward face extending radially outwardly of said outlet, and brackets secured to said fan housing at said forward face, and laterally inwardly of an opposed pair of bypass ducts; and
the brackets including an axial rear wall secured to the forward face and including bolt holes, a base floor defined between lateral sidewalls, said base floor having a grooved surface and a slot extending through said base floor, said slot extending for an axial length and for a lateral width, with a ratio of said length to said width being between 1.24 and 1.29.

3. A cabin air conditioning and temperature control system comprising:
a pack including an air cycle machine for delivering air through a heat exchanger, and from said heat exchanger into a cabin for an aircraft, said pack being secured to a ram air fan, said ram air fan including a fan rotor, a motor having a motor rotor driven and motor stator with said motor rotor and said motor stator received within a motor housing, a fan duct defined between an outer peripheral surface of said motor housing and an inner peripheral surface of a fan housing, an inlet to said fan rotor defined at one axial end of said fan housing, and an outlet defined at an opposed axial end, said fan duct connecting said inlet to said outlet, and air from said outlet passing over the heat exchanger, with said fan housing having a forward face extending radially outwardly of said outlet, and brackets secured to said fan housing at said forward face, and laterally inwardly of an opposed pair of bypass ducts; and
the bracket including an axial rear wall secured to the forward face and including bolt holes, a base floor defined between lateral sidewalls, said base floor having a grooved surface and a slot extending through said base floor, said slot extending for an axial length and for a lateral width, with a ratio of said length to said width being between 1.24 and 1.29.

4. A method of securing a ram air fan housing to a pack for a cabin air conditioning and temperature control system comprising the steps of:
(a) removing a bolt to allow the pack to be separated from said ram air fan at a bracket, removing said bracket from a housing of said ram air fan;
(b) replacing said removed bracket with a replacement bracket; and
(c) the replacement bracket having an axial rear wall to be secured to the housing and including bolt holes, a base floor defined between lateral sidewalls, said base floor having a grooved surface and a slot extending through said base floor, said slot extending for an axial length and for a lateral width, with a ratio of said length to said width being between 1.24 and 1.29.
